(19) United States
(12) Patent Application Publication
(10) Pub. No.: US 2023/0342676 A1
(43) Pub. Date: Oct. 26, 2023

(54) INTELLIGENT PREDICTION FOR EQUIPMENT MANUFACTURING MANAGEMENT SYSTEM

(71) Applicant: Dell Products L.P., Round Rock, TX (US)

(72) Inventors: Ajay Maikhuri, Bangalore (IN); Shibi Panikkar, Bangalore (IN); Rohit Gosain, Bangalore (IN)

(21) Appl. No.: 17/726,758

(22) Filed: Apr. 22, 2022

(51) Int. Cl. G06Q 10/06; G06Q 50/04

(52) U.S. Cl. CPC G06Q 10/063; G06Q 50/04

(57) ABSTRACT

Intelligent prediction techniques for equipment manufacturing management are disclosed. For example, a method comprises obtaining: (i) a structured description of at least one of components and processes associated with manufacturing of equipment in accordance with a given design; (ii) first manufacturing-related data from one or more potential manufacturing entities for the equipment; and (iii) second manufacturing-related data representing at least one of current attributes and historical attributes associated with manufacturing equipment at least similar to the equipment of the given design. The method then applies one or more prediction models based on at least portions of the obtained structured description, the first manufacturing-related data, and the second manufacturing-related data to compute a predicted attribute associated with manufacturing the equipment.

### FIELD

The field relates generally to information processing systems, and more particularly to equipment manufacturing management in such information processing systems.

### DESCRIPTION

An original equipment manufacturer (OEM) is an entity that sells equipment to customers that typically includes components purchased from suppliers (vendors) and assembled to form the final end product delivered to the customer. In one non-limiting example, assume an OEM sells a family of computing devices such as, for example, laptops. A laptop comprises a plurality of components (i.e., motherboard, keyboard, display, etc.) typically purchased from multiple suppliers. These components, many of which are themselves assembled from multiple other components (e.g., the motherboard comprises one or more processors and one or more memory devices), are assembled to form the laptop. In some cases, the OEM partners with an original design manufacturer/contract manufacturer (ODM/CM) at whose facilities the laptop is actually manufactured, e.g., the components are assembled into a final end product.

In this illustrative context, new product introduction (NPI) is an important process for OEMs. Generally, NPI includes two scenarios: (i) a new enhancement in an existing product, i.e., a next model of a product; and (ii) a new product or product family. For the OEM, both scenarios involve a combined effort between many different entities within or otherwise associated with the OEM, e.g., a marketing team, a product engineering team, suppliers, and the ODM/CM. By way of example, the OEM product engineering team, typically in conjunction with the OEM marketing team, design the equipment and the ODM/CM manufactures the equipment. To this end, the OEM attempts to work with the ODM/CM to determine, in advance, a manufacturing cost of the new enhancement/new product. However, if the OEM does not have sufficient knowledge of what main contributing factors go into the manufacturing cost determination, they may not be able to adequately estimate the manufacturing cost of the new enhancement/new product. As such, this poses a technical issue for the OEM because they may not be in an advantageous position to negotiate with potential ODMs/CMs for the manufacture of the new enhancement/new product.

### SUMMARY

Illustrative embodiments provide intelligent prediction techniques for equipment manufacturing management.

For example, in an illustrative embodiment, a method comprises the following steps performed by a processing platform comprising at least one processor coupled to at least one memory configured to execute program code. The method comprises obtaining: (i) a structured description of at least one of components and processes associated with manufacturing of equipment in accordance with a given design; (ii) first manufacturing-related data from one or more potential manufacturing entities for the equipment; and (iii) second manufacturing-related data representing at least one of current attributes and historical attributes associated with manufacturing equipment at least similar to the equipment of the given design. The method then applies one or more prediction models based on at least portions of the obtained structured description, the first manufacturing-related data, and the second manufacturing-related data to compute a predicted attribute associated with manufacturing the equipment.

Advantageously, one or more illustrative embodiments provide an automated engineering manufacturing management system configured to predict costs associated with the manufacture of a new equipment design. The automated engineering manufacturing management system, inter alia, enables an OEM to better negotiate with potential ODMs/CMs to manufacture the equipment.

These and other illustrative embodiments include, without limitation, apparatus, systems, methods and computer program products comprising processor-readable storage media.

### BRIEF DESCRIPTION OF THE DRAWINGS

FIG. 1 illustrates an equipment manufacturing environment in which one or more illustrative embodiment can be implemented.

FIG. 2 illustrates an information processing system environment for an equipment manufacturing management system with intelligent prediction functionality according to an illustrative embodiment.

FIG. 3 illustrates an exemplary clean sheet for use in an equipment manufacturing management system with intelligent prediction functionality according to an illustrative embodiment.

FIG. 4 illustrates an extracted portion of an exemplary clean sheet for use in an equipment manufacturing management system with intelligent prediction functionality according to an illustrative embodiment.

FIG. 5 illustrates a supplier sourcing process for use in an equipment manufacturing management system with intelligent prediction functionality according to an illustrative embodiment.

FIG. 6 illustrates a supplier grouping process for use in an equipment manufacturing management system with intelligent prediction functionality according to an illustrative embodiment.

FIG. 7 illustrates a component cost prediction process for use in an equipment manufacturing management system with intelligent prediction functionality according to an illustrative embodiment.

FIG. 8 illustrates a labor cost prediction process for use in an equipment manufacturing management system with intelligent prediction functionality according to an illustrative embodiment.

FIG. 9 illustrates a forecasted cost model generation process for use in an equipment manufacturing management system with intelligent prediction functionality according to an illustrative embodiment.

FIG. 10 illustrates a manufacturing overhead prediction table for use in an equipment manufacturing management system with intelligent prediction functionality according to an illustrative embodiment.

FIG. 11 illustrates an equipment manufacturing management methodology with intelligent prediction functionality according to an illustrative embodiment.

FIG. 12 illustrates an example of a processing platform that may be utilized to implement at least a portion of an information processing system for equipment manufacturing management with intelligent prediction functionality according to an illustrative embodiment.

### DETAILED DESCRIPTION

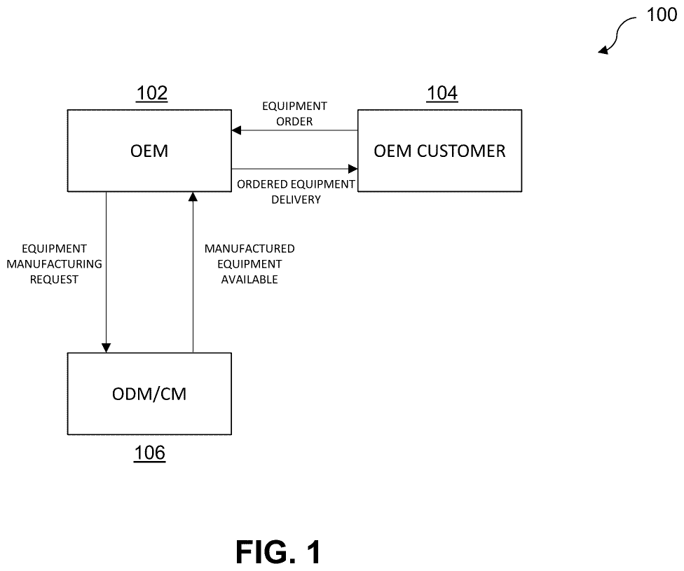

Referring initially to FIG. 1, an equipment manufacturing environment 100 is depicted. As generally shown, assume an OEM 102 receives an equipment order request from an OEM customer 104. In some manufacturing industries, it is understood that OEM 102 may use an ODM/CM 106 to manufacture the ordered equipment. In such a case, after a negotiation, assume OEM 102 sends a request to ODM/CM 106 to manufacture the ordered equipment. The manufactured equipment is then made available by ODM/CM 106, which is then delivered to OEM customer 104.

It is realized that an OEM may have an ODM/CM manufacture their products for reasons such as, but not limited to, cost effectiveness and to avoid bottlenecks in their own manufacturing facilities. The ODM/CM not only assembles the final product (e.g., a laptop) but may also assemble different sub-assemblies or sub-products that are part of the final product using raw materials and processes, as well as commodity parts (also referred to herein as commodities, e.g., processors, memory chips), procured from suppliers. It is further realized that the ODM/CM can readily derive a manufacturing cost from their history of manufacturing similar products.

The technical problem for the OEM is they do not have this data to derive or predict the manufacturing cost of the new product/enhancement that they are planning to introduce (i.e., new product introduction or NPI). Thus, there is no systematic way for the OEM to, inter alia, challenge the ODM/CM quotation for manufacturing different components of the finished good and assembling the different components to make the final product due to lack of the cost details of the same. At best, in an existing approach, the OEM can attempt to obtain data to manually determine the manufacturing cost for an NPI. However, this is inefficient and ultimately ineffective, and thus compromises the OEM's negotiating ability with respect to the final cost of a manufactured product. If an OEM's competitors can negotiate for a better cost with an ODM/CM for the same competing products, they can release the competing product for a lower price in the market.

Illustrative embodiments overcome the above and other technical drawbacks with existing equipment manufacturing approaches by providing an automated equipment manufacturing management system with intelligent prediction functionality. As will be further explained in detail, an equipment manufacturing management system according to illustrative embodiments operates in response to a bill of material (BOM) for the new equipment being introduced (e.g., new product or enhancement to existing product) and systematically identifies the cost of the BOM with effective and unified collaboration of one or more suppliers and one or more ODMs/CMs and derives the variable cost associated with the engineering process and the labor cost.

More particularly, illustrative embodiments create a so-called “clean sheet” based on the BOM and a history of procured items, and generate a sequenced clean sheet. As illustratively used herein, clean sheeting refers to an analysis of a product's cost structure to assist manufacturers (e.g., OEMs) in improving product design and, inter alia, capturing cost savings. It is understood that, in order to identify cost-reduction opportunities, OEMs need to understand the main contributing factors for each product's manufacturing process. Also known as a “should-cost analysis,” clean sheeting serves as a useful OEM technique that involves, e.g., modeling commodities/raw material and conversion costs of a good, allowing for a better understanding of overhead, profit and manufacturing efficiency.

With a sequenced clean sheet, the equipment manufacturing management system predicts the cost for any time series of manufacturing dates, automatically creates engineering models (e.g., mechanical engineering (ME) models, electrical engineering (EE) models, non-recurring expenses (NRE) models, human resource (HR) models etc.), and re-calculates the predicted cost based on the engineering models to yield a final predicted cost as well as one or more negotiation analytics recommendations and/or reports.

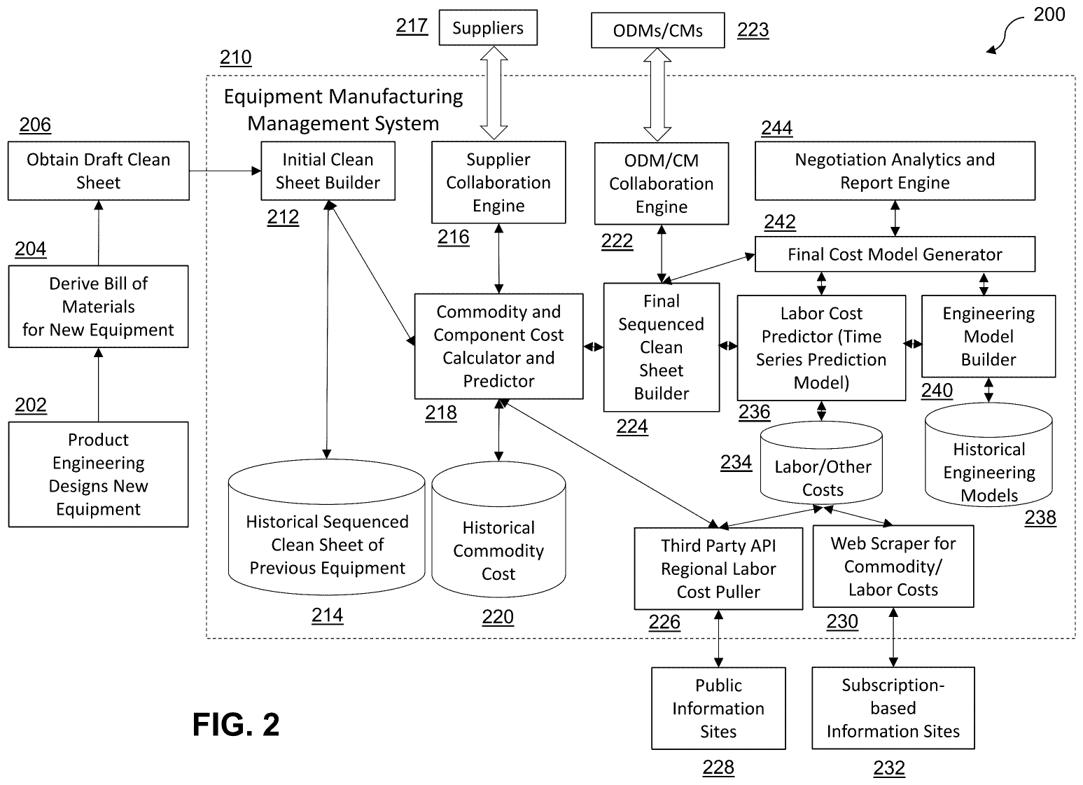

FIG. 2 illustrates an information processing system environment 200 for an equipment manufacturing management system with intelligent prediction functionality according to an illustrative embodiment. As shown as steps performed by one or more entities within a given OEM to generate initial input to an equipment manufacturing management system 210, a product engineering team designs new equipment in step 202. It is understood that the new equipment may, for example, be either an enhancement to an existing OEM product or an entirely new OEM product. From the design, a bill of material (BOM) document is generated in step 204. From the BOM, a draft clean sheet is obtained in step 206. An example of a clean sheet will be described herein in the context of subsequent figures.

As further shown in FIG. 2, an equipment manufacturing management system 210 comprises the following modules operatively coupled as shown and explained in detail below: an initial clean sheet builder 212, a data store 214 with a historical sequenced clean sheet of previous (parent) equipment; a supplier collaboration engine 216 (configured with a graphical user interface or other interface for one or more suppliers 217), a commodity and component cost calculator and predictor 218, a data store 220 of historical commodity cost; an ODM/CM collaboration engine 222 (configured with a graphical user interface or other interface for one or more ODMs/CMs 223), a final sequenced clean sheet builder 224, a third party application programming interface (API) regional labor cost puller 226 (configured to access one or more external public information sites 228); a web scraper for commodity/labor costs 230 (configured to access one or more external subscription-based information sites 232); a data store 234 for labor and other costs; a labor cost predictor 236 with time series prediction model; a data store 238 for historical engineering models, an engineering model builder 240; a final cost model generator 242; and a negotiation analytics and report engine 244.

Thus, after obtaining the new equipment BOM and a draft clean sheet from a product engineering team and/or a commodity management team of the OEM, initial clean sheet builder 212 of equipment manufacturing management system 210 (hereinafter system 210) obtains commodity and other component costs predicted by predictor 218 based on historical commodity cost data from data store 220. Initial clean sheet builder 212 also obtains a sequenced clean sheet from data store 214 for a previous version of the equipment (parent equipment) when the NPI is a product enhancement rather than a completely new product. If this is a new product, a sequenced clean sheet can be generated manually by the OEM and/or semi-automatically in conjunction with system 210, and then automatically adjusted as needed.

System 210 is configured to enable collaboration with one or more suppliers, via supplier collaboration engine 216, to obtain the cost from suppliers for new commodities and components over time in accordance with a standardized template. That is, supplier collaboration engine 216 comprises an interface for suppliers to provide data to system 210 as requested or otherwise agreed to with the OEM. System 210 is further configured to enable collaboration with one or more ODMs/CMs, via ODM/CM collaboration engine 222, to obtain their proposed manufacturing process for the new equipment in order to predict the future cost and build the sequence of operations. That is, ODM/CM collaboration engine 222 comprises an interface for ODMs/CMs to provide data to system 210 as requested or otherwise agreed to with the OEM.

Final sequenced clean sheet builder 224 generates the sequenced clean sheet with a predicted price for historically procured items and historical process costs. This sequenced clean sheet can also be stored in data store 214 for future use. More particularly, when a subsequent NPI occurs, the stored sequenced clean sheet can be used as a historical basis.

As further shown, system 210 comprises a third party API 226 that is configured to pull current and predicted labor cost data from one or more public information sites 228. Similarly, a web scraper 230 can be used to obtain commodity and labor cost data from one or more subscription-based information sites 232 (for example, but not limited to, HIS, Bloomberg, etc.). The external data from sites 228 and 232 can be refreshed periodically and stored in data store 234 as a knowledge base for future use.

Further, engineering model builder 240 creates engineering Models (e.g., EE, ME, NRE, HR models) which are used by labor cost predictor 236 along with the final sequenced clean sheet from engineering model builder 240 to get the predicted time series cost for engineering. A final cost model is generated by generator 242, and negotiation analytics and reports are generated in response to the final cost model. Further details of the functionalities of modules in system 210 and their interactions will be explained below in the context of subsequent figures.

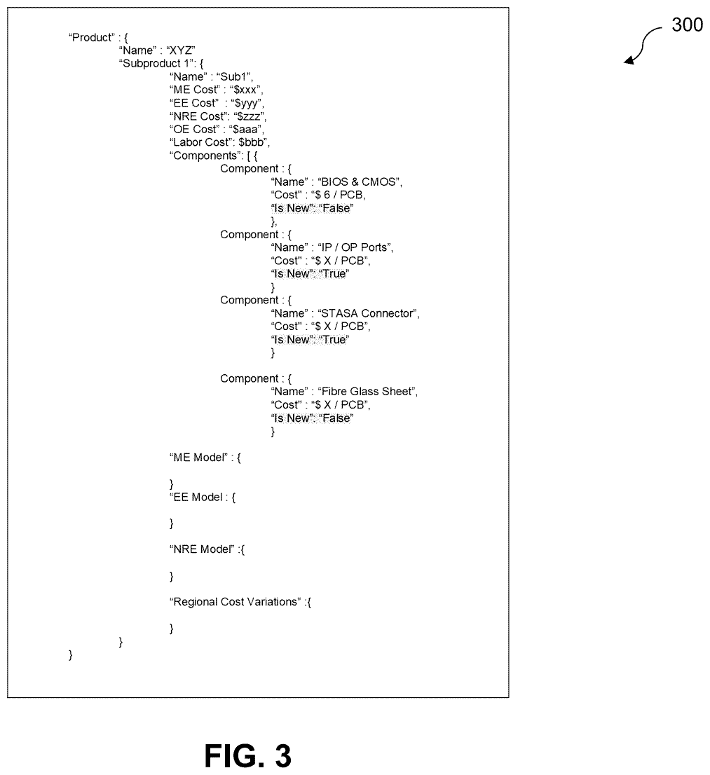

FIG. 3 illustrates an exemplary sequenced clean sheet 300 for use in system 210. A clean sheet comprises the details of the components (e.g., raw materials and commodities) and processes needed for a specific item to be built in a given sequence for a probable cost. In existing equipment manufacturing management techniques, the clean sheet is built manually in tools such as Excel (i.e., the clean sheet is an Excel spreadsheet). In system 210, initial clean sheet builder 212 receives as input a draft clean sheet generated from a proposed BOM, and compares this data with the historical data of a parent equipment model and build. In one or more illustrative embodiments, the resulting clean sheet output by initial clean sheet builder 212 can be represented as an electronic document in a JavaScript Object Notation (JSON) format. As shown in exemplary sequenced clean sheet 300, it is assumed the new equipment is a laptop with is comprised of components including keyboard, motherboard, monitor, power manager, etc.

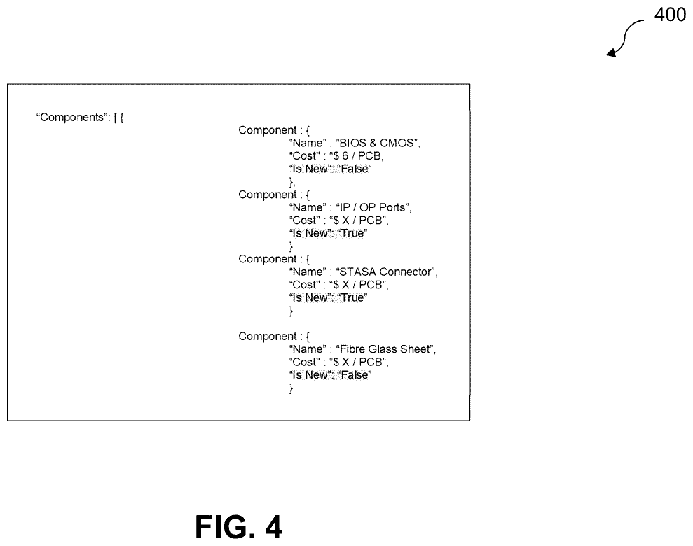

Supplier collaboration engine 216 and commodity and component cost calculator and predictor 218 functionalities will be further explained in the context of FIGS. 4-7. As explained above, supplier collaboration engine 216 comprises an interface for commodity/other component suppliers to supply requested data to system 210. This presents an improvement over existing email or telephone communication between the OEM and suppliers/vendors. For example, one or more suppliers provide their predicted costs of some commodity (e.g., memory chip) directly to supplier collaboration engine 216, and commodity and component calculator and predictor 218 compares the predicted costs to historical cost data for that same commodity from data store 220.

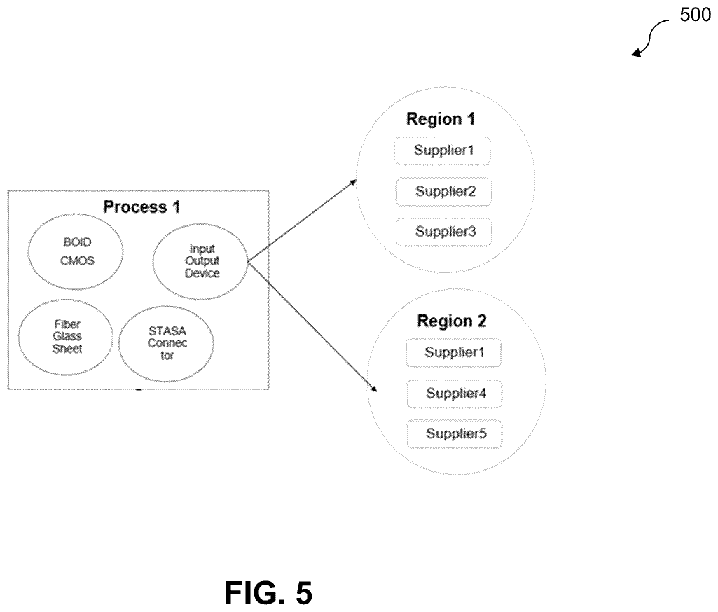

FIG. 4 illustrates an extracted portion 400 of sequenced clean sheet 300 of FIG. 3. Assume that portion 400 refers to a portion of the new equipment, e.g., one assembly (Sub Product 1) of a larger assembly (Sub Product). First, supplier collaboration engine 216 identifies suppliers for components of Sub Product 1 in different geographic regions. This is depicted in supplier sourcing process 500 of FIG. 5 for two regions (Region 1 and Region 2). In supplier sourcing process 500, the cost of the components from different suppliers in the two regions over a period of time is obtained. Multiple suppliers are used for supplier sourcing process 500 to, inter alia, eliminate monopolization by one supplier for a given component.

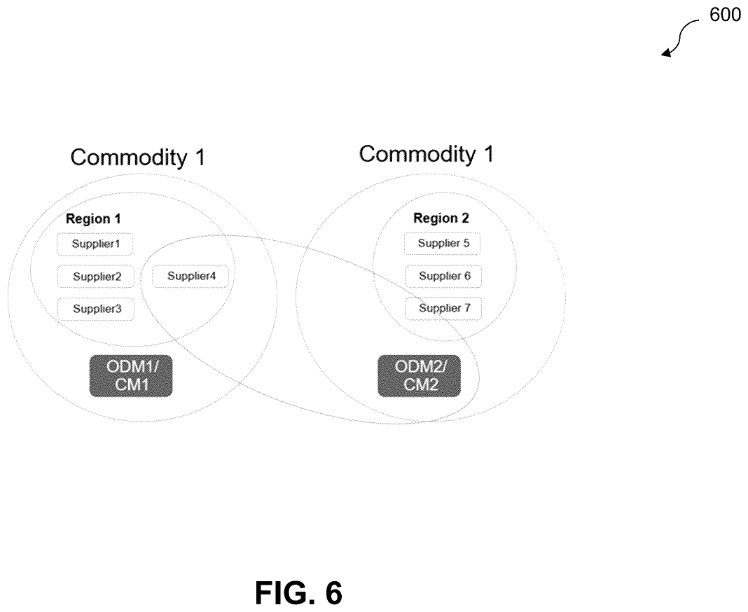

It is realized that each ODM/CM typically uses different suppliers for the same commodity or raw material in each region. Thus, in each region, system 210 can create a standard template for collecting data from the suppliers. As shown in supplier grouping process 600 of FIG. 6, system 210 groups the suppliers in the region for each ODM/CM. The same commodity of different ODMs/CMs can be sourced by different suppliers or by a common supplier. For example, assume that Commodity 1 for ODM1/CM1 is classified as shown in FIG. 6. Once the classification is done, then system 210 sources the transportation cost for each commodity supply. This can be sourced from historical transportation costs for a supplier in a different region (e.g., as shown in FIG. 6, ODM2/CM2 can source from supplier 4 in region 1). Now system 210 has the historical data and trends of the cost of different parts of the assembly along with current costs supplied by the suppliers, and can predict the cost for the commodity.

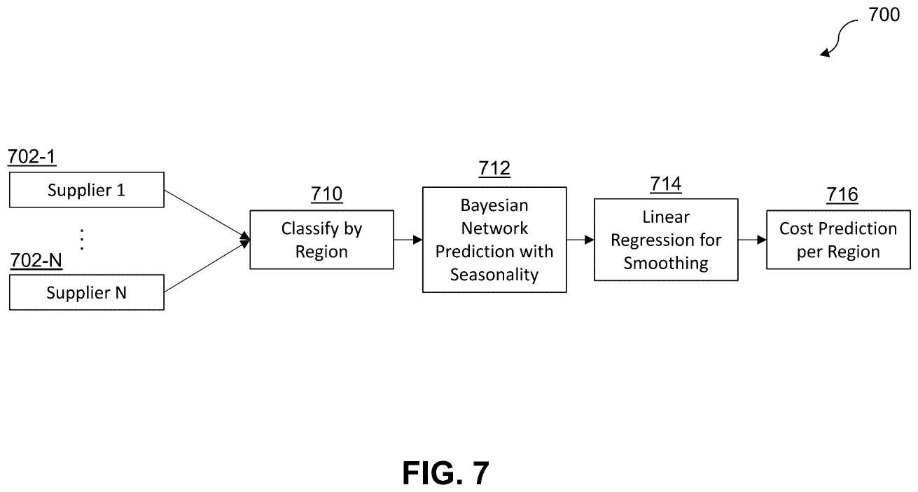

FIG. 7 illustrates a cost prediction model 700 that can be used by commodity and component cost calculator and predictor 218. Cost from different suppliers in different regions with seasonal cost variation including transportation costs can be determined. As shown, a plurality of suppliers 702-1, . . . , 702-N are classified by region in step 710. A Bayesian network prediction algorithm with seasonality is applied in step 712 and prediction results are smoothed using a linear regression algorithm in step 714. The cost prediction per region is output in step 716. One of ordinary skill in the art will understand the conventional predictive functions applied by Bayesian network techniques, as well as conventional linear regression smoothing functions.

Advantageously now that system 210 has current and future costs of all commodities and raw materials needed for a product, if a supplier is quoting excess cost for existing commodities, the OEM can learn this based on previous commodity trends and better negotiate with the supplier.

For new commodities (e.g., for which public Internet-based information may not be readily available), system 210 can use the web scraping result of web scraper 230 for determining negotiation analytics. For example, system 210 enables users to browse commodity manufacturers' websites and mark the cost to be scraped. There are a variety of existing web scraping tools and algorithms available that can be employed in illustrative embodiments. The results can be used for the supplier negotiation mainly for new commodity in the assembly.

Labor cost prediction according to illustrative embodiments will now be further explained. It is to be understood that while the cost of commodities can bee predicted by prices of the components, some assemblies require purchase of raw materials that then need to be processed (i.e., by human and/or machines) as part of the overall equipment manufacturing process However, even with commodities as well as other components, they typically have to be stored, inspected, installed, tested, etc., also incur labor costs.

It is assumed that, for an OEM, its product engineering team has high level engineering models that can be used for determining processing and other labor that incur costs such as, for example, mechanical costs (e.g., machine cost, lab cost, warehouse cost, etc.), electrical costs (e.g., switchboard, electric charges, etc.), human resource costs (e.g., resources needed for design and execution), non-recurring costs (e.g., new machines and new processes to setup for the new assemblies). ODM/CM collaboration engine 222 enables the product engineering team to validate assumptions and come up with the cost model for each engineering model. ODMs/CMs can login to ODM/CM collaboration engine 222 and verify the data provided by the product engineering team.

Once collected, there can be additional commodities/raw material required for the new process. This will go back to supplier collaboration engine 216 to obtain the cost from the supplier. With this information, system 210 re-builds the sequenced clean sheet for the assembly in the current clean sheet.

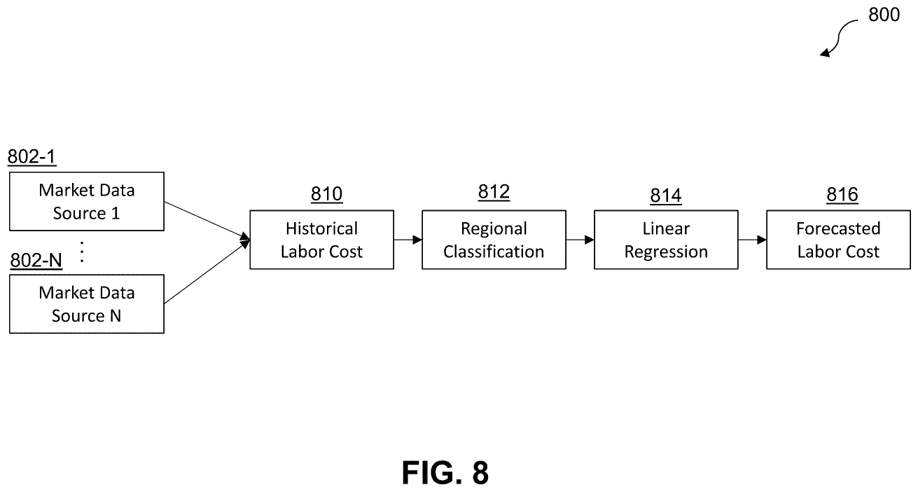

Once an engineering model is obtained from engineering model builder 240, system 210 determines labor costs needed for the engineering model. In one or more embodiments, system 210 leverages labor cost statistical providers (sites 228 and/or 232), such as Bloomberg or another source, to get the current and historical labor cost in different regions. FIG. 8 illustrates a labor cost prediction model 800 wherein labor costs in different regions can be determined. As shown, a plurality of market data sources 802-1, . . . , 802-N are accessed to get historical labor costs in step 810. Step 812 classifies the costs by region. A linear regression algorithm is used in step 814 to generate and output the forecasted labor costs in step 816. Again, one of ordinary skill in the art will understand the conventional linear regression functions applied in step 814.

As mentioned above, once system 210 has the initial engineering models as a result of ODM/CM collaboration etc., system 210 builds each engineering final model for the new assembly and engineering process (note that business can override) with commodity and labor costs. System 210 predicts the engineering process cost using a linear regression model with seasonal autoregressive integrated moving average (SARIMA) time series. Since system 210 already has the time series predicted commodity/raw material cost, labor cost and engineering process, system 210 builds the time series predicted cost for each engineering model and human resources cost.

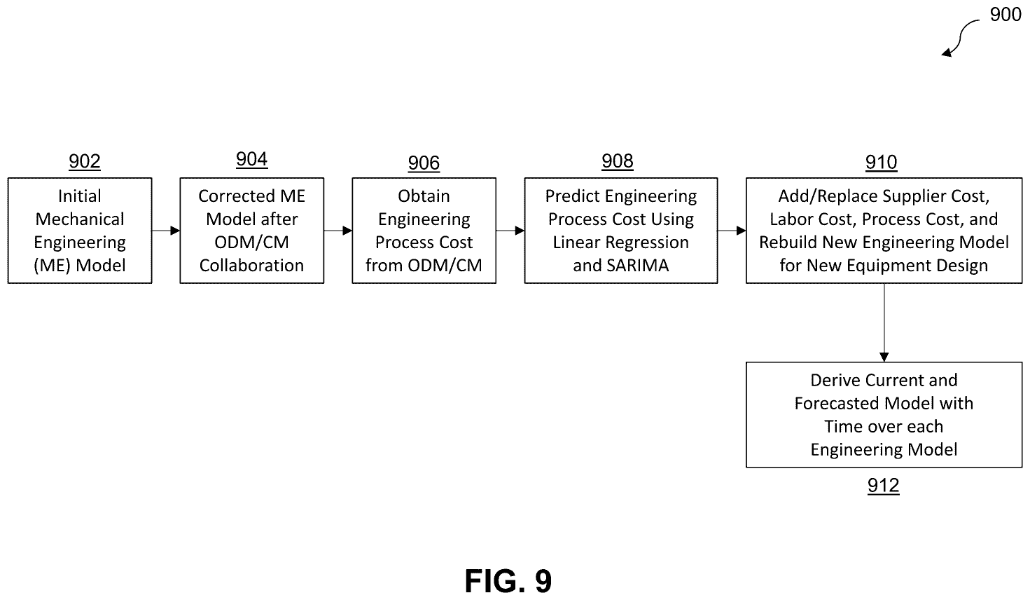

This is shown in forecasted labor cost model generation process 900 of FIG. 9. FIG. 9 illustratively depicts use of an ME engineering model, however, it is to be understood that the same process can be applied to other types of engineering models (EE, NRE, HR, etc.). More particularly, as shown in step 902, forecasted labor cost model generation process 900 obtains an initial ME model. Following ODM/CM collaboration as explained above, step 904 generates a corrected ME model. Based on engineering process costs quoted by the ODM/CM and obtained in step 906, predicted engineering cost is generated in step 908 using linear regression and SARIMA techniques. Step 910 adds/replaces supplier cost, labor cost, process cost, and rebuilds a new engineering model for the new equipment design. Step 912 then derives current and forecasted models over time for each engineering model.

Accordingly, with the final sequenced clean sheet (with current and time series forecasted cost), current and forecasted engineering models, system 210 can plot the current and should-be cost with all details (e.g., commodity cost, raw material cost, labor cost, engineering process cost, HR cost, NRE cost) and build analytics (e.g., 244 in FIG. 2) for the OEM procurement team to effectively negotiate with ODMS/OCs for the manufacturing cost now and in the future.

Still further, it is realized that there can be some overhead cost for the ODM/OC that cannot always be accounted for by the OEM. Overhead for each ODM/OC will be different (e.g., due to salary difference costs, regional-unique costs, etc.). In accordance with illustrative embodiments, once system 210 matures (i.e., executes for a length of time and develops a deep knowledge base), the overhead (so-called padding) over a period of time can be determined by system 210.

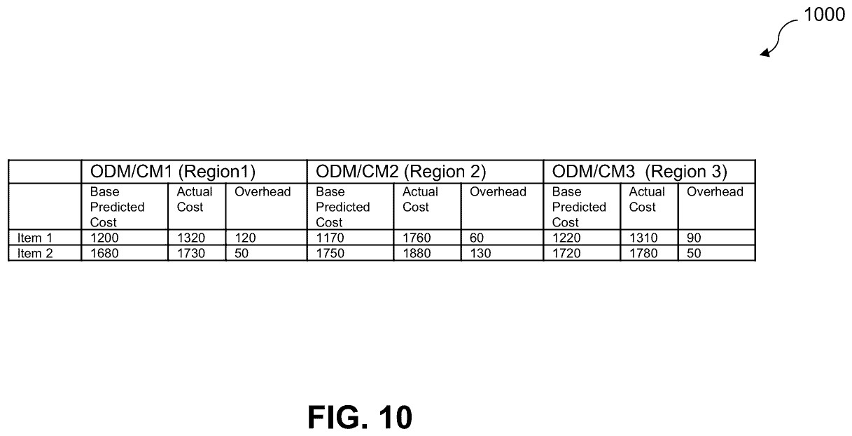

A manufacturing overhead prediction table 1000 generated by system 210 is shown in FIG. 10. More particularly, once system 210 has determined the overhead for each ODM/CM, it can forecast the overhead over a period of time with seasonality changes which can be leveraged in various ODM/CM negotiation strategies. For an aggressive negotiation strategy, the following metric can be used: Predicted Total Cost=Predicted Base Cost+Minimum Overhead for a specific type of product (or start with 10% less on total cost). For a moderate negotiation strategy, the metric can be: Predicted Total Cost=Predicted Base Cost+Predicted Overhead. The OEM procurement team can take both negotiation strategies with all data. The ODM/CM may quote somewhere between an aggressive cost and a moderate cost (e.g., minimum and maximum range). The new overhead (Agreed Cost−Predicted Actual Cost) can be fed back to system 210 for the future negotiations with the same ODM/CM. Advantageously, system 210 continuously and iteratively learns and gives the total cost.

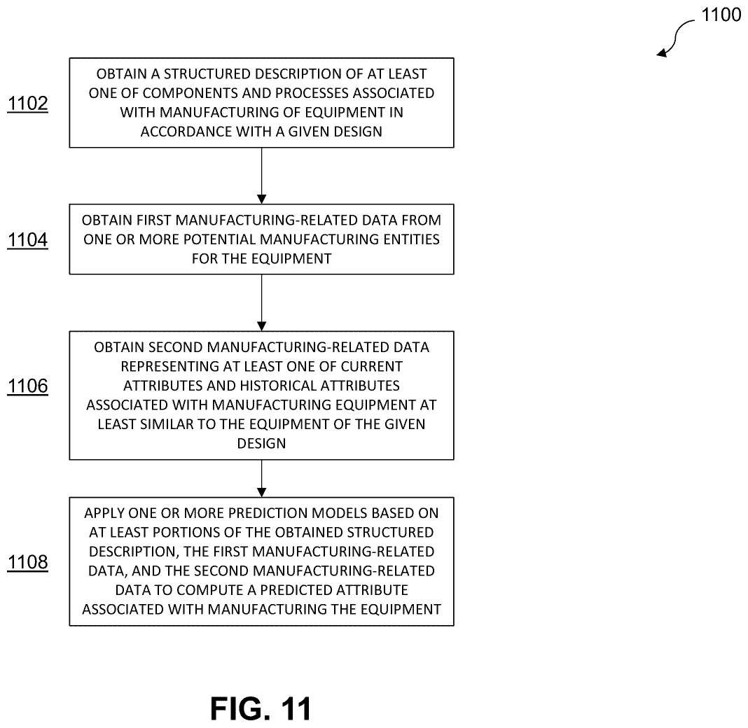

FIG. 11 illustrates an equipment manufacturing management methodology 1100 (also hereinafter referred to as methodology 1100) with intelligent prediction functionality according to an illustrative embodiment. It is to be understood that methodology 1100 can be implemented in system 210 of FIG. 2 in one or more illustrative embodiments.

As shown, step 1102 obtains a structured description of at least one of components and processes associated with manufacturing of equipment in accordance with a given design. In one or more illustrative embodiments, the structured description comprises a clean sheet as illustratively described herein.

Step 1104 obtains first manufacturing-related data from one or more potential manufacturing entities for the equipment. In one or more illustrative embodiments, first manufacturing-related data comprises cost data, and one or more potential manufacturing entities comprise one or more ODMs/CMs as illustratively described herein.

Step 1106 obtains second manufacturing-related data representing at least one of current attributes and historical attributes associated with manufacturing equipment at least similar to the equipment of the given design. In one or more illustrative embodiments, second manufacturing-related data comprises cost data, such that the current attributes comprise current costs and the historical attributes comprise historical costs associated with manufacturing equipment at least similar to the equipment of the given design (e.g., parent equipment and the like) as illustratively described herein. The term “similar to” with respect to the equipment illustratively means equipment that is related to the newly designed equipment or that has several common components and/or manufacturing processes associated therewith.

Step 1108 applies one or more prediction models based on at least portions of the obtained structured description, the first manufacturing-related data, and the second manufacturing-related data to compute a predicted attribute associated with manufacturing the equipment.

Advantageously, as described herein, illustrative embodiments provide a system and method to predict the cost of an enhanced product or next model of a hardware product based on commodity cost, raw material cost, labor cost, and other costs, using a SARIMA-based time series prediction model. Systems and methods also source the cost from different suppliers and corelate with existing cost to predict the time series cost variation in the future for negotiation. Systems and method also build automated engineering models for new products/assemblies and derive costs for each model for current and future uses. Systems and methods also relearn to understand overhead cost for each ODM/CM and refine the cost prediction for each ODM/CM. One or more of the prediction models used herein may comprise one or more artificial intelligence/machine learning (AI/ML) algorithms or other intelligent prediction functionalities.

Illustrative embodiments are described herein with reference to exemplary information processing systems and associated computers, servers, storage devices and other processing devices. It is to be appreciated, however, that embodiments are not restricted to use with the particular illustrative system and device configurations shown. Accordingly, the term “information processing system” as used herein is intended to be broadly construed, so as to encompass, for example, processing systems comprising cloud computing and storage systems, as well as other types of processing systems comprising various combinations of physical and virtual processing resources. An information processing system may therefore comprise, for example, at least one data center or other type of cloud-based system that includes one or more clouds hosting tenants that access cloud resources. Cloud infrastructure can include private clouds, public clouds, and/or combinations of private/public clouds (hybrid clouds).

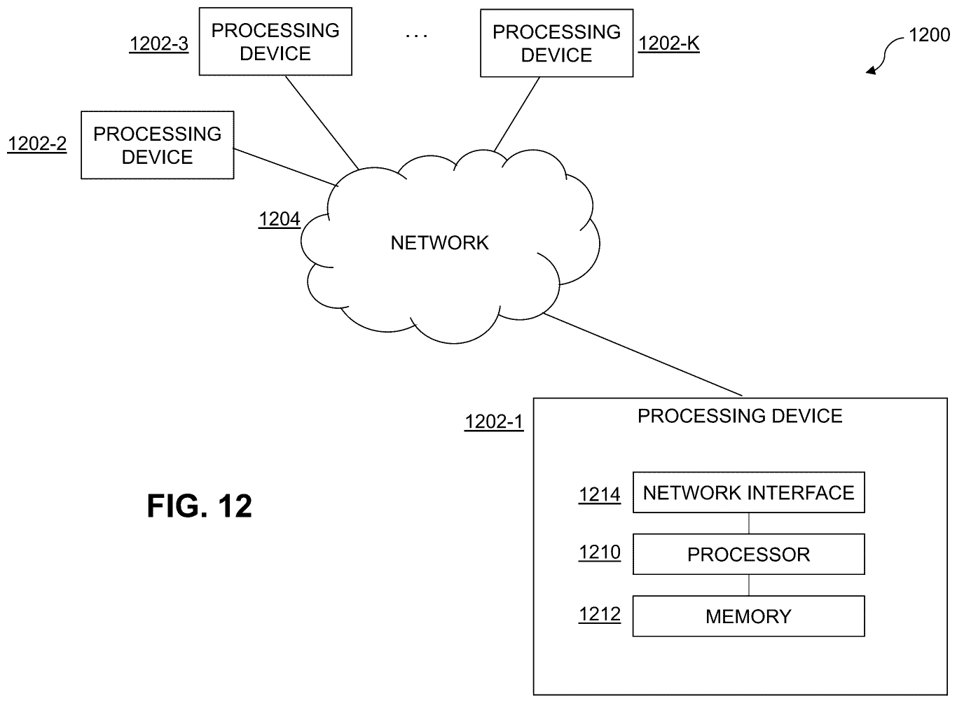

FIG. 12 depicts a processing platform 1200 used to implement information processing systems/processes depicted in FIGS. 1 through 11, respectively, according to an illustrative embodiment. More particularly, processing platform 1200 is a processing platform on which a computing environment with functionalities described herein can be implemented.

The processing platform 1200 in this embodiment comprises a plurality of processing devices, denoted 1202-1, 1202-2, 1202-3, . . . 1202-K, which communicate with one another over network(s) 1204. It is to be appreciated that the methodologies described herein may be executed in one such processing device 1202, or executed in a distributed manner across two or more such processing devices 1202. It is to be further appreciated that a server, a client device, a computing device or any other processing platform element may be viewed as an example of what is more generally referred to herein as a “processing device.” As illustrated in FIG. 12, such a device generally comprises at least one processor and an associated memory, and implements one or more functional modules for instantiating and/or controlling features of systems and methodologies described herein. Multiple elements or modules may be implemented by a single processing device in a given embodiment. Note that components described in the architectures depicted in the figures can comprise one or more of such processing devices 1202 shown in FIG. 12. The network(s) 1204 represent one or more communications networks that enable components to communicate and to transfer data therebetween, as well as to perform other functionalities described herein.

The processing device 1202-1 in the processing platform 1200 comprises a processor 1210 coupled to a memory 1212. The processor 1210 may comprise a microprocessor, a microcontroller, an application-specific integrated circuit (ASIC), a field programmable gate array (FPGA) or other type of processing circuitry, as well as portions or combinations of such circuitry elements. Components of systems as disclosed herein can be implemented at least in part in the form of one or more software programs stored in memory and executed by a processor of a processing device such as processor 1210. Memory 1212 (or other storage device) having such program code embodied therein is an example of what is more generally referred to herein as a processor-readable storage medium. Articles of manufacture comprising such computer-readable or processor-readable storage media are considered embodiments of the invention. A given such article of manufacture may comprise, for example, a storage device such as a storage disk, a storage array or an integrated circuit containing memory. The term “article of manufacture” as used herein should be understood to exclude transitory, propagating signals.

Furthermore, memory 1212 may comprise electronic memory such as random-access memory (RAM), read-only memory (ROM) or other types of memory, in any combination. The one or more software programs when executed by a processing device such as the processing device 1202-1 causes the device to perform functions associated with one or more of the components/steps of system/methodologies in FIGS. 1 through 11. One skilled in the art would be readily able to implement such software given the teachings provided herein. Other examples of processor-readable storage media embodying embodiments of the invention may include, for example, optical or magnetic disks.

Processing device 1202-1 also includes network interface circuitry 1214, which is used to interface the device with the networks 1204 and other system components. Such circuitry may comprise conventional transceivers of a type well known in the art.

The other processing devices 1202 (1202-2, 1202-3, . . . 1202-K) of the processing platform 1200 are assumed to be configured in a manner similar to that shown for computing device 1202-1 in the figure.

The processing platform 1200 shown in FIG. 12 may comprise additional known components such as batch processing systems, parallel processing systems, physical machines, virtual machines, virtual switches, storage volumes, etc. Again, the particular processing platform shown in this figure is presented by way of example only, and the system shown as 1200 in FIG. 12 may include additional or alternative processing platforms, as well as numerous distinct processing platforms in any combination.

Also, numerous other arrangements of servers, clients, computers, storage devices or other components are possible in processing platform 1200. Such components can communicate with other elements of the processing platform 1200 over any type of network, such as a wide area network (WAN), a local area network (LAN), a satellite network, a telephone or cable network, or various portions or combinations of these and other types of networks.

Furthermore, it is to be appreciated that the processing platform 1200 of FIG. 12 can comprise virtual (logical) processing elements implemented using a hypervisor. A hypervisor is an example of what is more generally referred to herein as “virtualization infrastructure.” The hypervisor runs on physical infrastructure. As such, the techniques illustratively described herein can be provided in accordance with one or more cloud services. The cloud services thus run on respective ones of the virtual machines under the control of the hypervisor. Processing platform 1200 may also include multiple hypervisors, each running on its own physical infrastructure. Portions of that physical infrastructure might be virtualized.

As is known, virtual machines are logical processing elements that may be instantiated on one or more physical processing elements (e.g., servers, computers, processing devices). That is, a “virtual machine” generally refers to a software implementation of a machine (i.e., a computer) that executes programs like a physical machine. Thus, different virtual machines can run different operating systems and multiple applications on the same physical computer. Virtualization is implemented by the hypervisor which is directly inserted on top of the computer hardware in order to allocate hardware resources of the physical computer dynamically and transparently. The hypervisor affords the ability for multiple operating systems to run concurrently on a single physical computer and share hardware resources with each other.

It was noted above that portions of the computing environment may be implemented using one or more processing platforms. A given such processing platform comprises at least one processing device comprising a processor coupled to a memory, and the processing device may be implemented at least in part utilizing one or more virtual machines, containers or other virtualization infrastructure. By way of example, such containers may be Docker containers or other types of containers.

The particular processing operations and other system functionality described in conjunction with FIGS. 1-12 are presented by way of illustrative example only, and should not be construed as limiting the scope of the disclosure in any way. Alternative embodiments can use other types of operations and protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the above-described embodiments of the invention are presented for purposes of illustration only. Many variations may be made in the particular arrangements shown. For example, although described in the context of particular system and device configurations, the techniques are applicable to a wide variety of other types of data processing systems, processing devices and distributed virtual infrastructure arrangements. In addition, any simplifying assumptions made above in the course of describing the illustrative embodiments should also be viewed as exemplary rather than as requirements or limitations of the invention.

What is claimed is:

1. An apparatus comprising:
a processing platform comprising at least one processor coupled to at least one memory, the processing platform, when executing program code, is configured to:
obtain a structured description of at least one of components and processes associated with manufacturing of equipment in accordance with a given design;
obtain first manufacturing-related data from one or more potential manufacturing entities for the equipment;
obtain second manufacturing-related data representing at least one of current attributes and historical attributes associated with manufacturing equipment at least similar to the equipment of the given design; and
apply one or more prediction models based on at least portions of the obtained structured description, the first manufacturing-related data, and the second manufacturing-related data to compute a predicted attribute associated with manufacturing the equipment.

2. The apparatus of claim 1, wherein the processing platform, when executing program code, is further configured to:
perform an analysis on the predicted attribute; and
generate one or more recommendations based on the analysis.

3. The apparatus of claim 2, wherein the one or more recommendations comprise a computation-based strategy for negotiating with the one or more potential manufacturing entities to manufacture the equipment in accordance with the given design.

4. The apparatus of claim 1, wherein the first manufacturing-related data comprises first cost data and the second manufacturing-related data comprises second cost data such that the predicted attribute comprises a predicted cost associated with manufacturing the equipment in accordance with the given design.

5. The apparatus of claim 1, wherein applying the one or more prediction models based on at least portions of the obtained structured description, the first manufacturing-related data, and the second manufacturing-related data to compute the predicted attribute associated with manufacturing the equipment further comprises respectively computing two or more values for the predicted attribute for a given time series comprising two or more manufacturing dates.

6. The apparatus of claim 1, wherein applying the one or more prediction models based on at least portions of the obtained structured description, the first manufacturing-related data, and the second manufacturing-related data to compute the predicted attribute associated with manufacturing the equipment further comprises respectively computing two or more values for the predicted attribute for two or more geographic regions.

7. The apparatus of claim 1, wherein the one or more prediction models comprise a seasonal autoregressive integrated moving average based prediction model.

8. The apparatus of claim 1, wherein the processing platform, when executing program code, is further configured to provide an interface for obtaining the first manufacturing-related data from the one or more potential manufacturing entities for the equipment.

9. The apparatus of claim 1, wherein the processing platform, when executing program code, is further configured to provide an interface for obtaining at least a portion of the first manufacturing-related data from one or more suppliers of components useable by the one or more potential manufacturing entities for the equipment.

10. The apparatus of claim 1, wherein the components in the structured description of at least one of components and processes associated with manufacturing of the equipment comprise one or more of commodities and raw materials.

11. The apparatus of claim 1, wherein the processes in the structured description of at least one of components and processes associated with manufacturing of the equipment comprise at least one of assembly-based processes and engineering-based processes.

12. A method comprising:
obtaining a structured description of at least one of components and processes associated with manufacturing of equipment in accordance with a given design;
obtaining first manufacturing-related data from one or more potential manufacturing entities for the equipment;
obtaining second manufacturing-related data representing at least one of current attributes and historical attributes associated with manufacturing equipment at least similar to the equipment of the given design; and
applying one or more prediction models based on at least portions of the obtained structured description, the first manufacturing-related data, and the second manufacturing-related data to compute a predicted attribute associated with manufacturing the equipment;
wherein the obtaining and applying steps are performed by a processing platform comprising at least one processor coupled to at least one memory executing program code.

13. The method of claim 12, further comprising:
performing an analysis on the predicted attribute; and
generating one or more recommendations based on the analysis.

14. The method of claim 13, wherein the one or more recommendations comprise a computation-based strategy for negotiating with the one or more potential manufacturing entities to manufacture the equipment in accordance with the given design.

15. The method of claim 12, wherein the first manufacturing-related data comprises first cost data and the second manufacturing-related data comprises second cost data such that the predicted attribute comprises a predicted cost associated with manufacturing the equipment in accordance with the given design.

16. The method of claim 12, wherein the one or more prediction models comprise a seasonal autoregressive integrated moving average based prediction model.

17. A computer program product comprising a non-transitory processor-readable storage medium having stored therein program code of one or more software programs, wherein the program code when executed by at least one processing device cause the at least one processing device to:
obtain a structured description of at least one of components and processes associated with manufacturing of equipment in accordance with a given design;
obtain first manufacturing-related data from one or more potential manufacturing entities for the equipment;
obtain second manufacturing-related data representing at least one of current attributes and historical attributes associated with manufacturing equipment at least similar to the equipment of the given design; and
apply one or more prediction models based on at least portions of the obtained structured description, the first manufacturing-related data, and the second manufacturing-related data to compute a predicted attribute associated with manufacturing the equipment.

18. The computer program product of claim 17, wherein the program code when executed by the at least one processing device further cause the at least one processing device to:
perform an analysis on the predicted attribute; and
generate one or more recommendations based on the analysis.

19. The computer program product of claim 18, wherein the one or more recommendations comprise a computation-based strategy for negotiating with the one or more potential manufacturing entities to manufacture the equipment in accordance with the given design.

20. The computer program product of claim 17, wherein the first manufacturing-related data comprises first cost data and the second manufacturing-related data comprises second cost data such that the predicted attribute comprises a predicted cost associated with manufacturing the equipment in accordance with the given design.
